(19) United States
(12) Patent Application Publication
(10) Pub. No.: US 2010/0004994 A1
(43) Pub. Date: Jan. 7, 2010

(54) METHODS FOR FACILITATING COMMUNICATIONS BETWEEN BUSINESSES AND CONSUMERS

(75) Inventor: Scott A. Rocke, Troy, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Global Launch Incorporated, Dublin, OH (US)

(21) Appl. No.: 12/497,150

(22) Filed: Jul. 2, 2009

Related U.S. Application Data
(60) Provisional application No. 61/077,545, filed on Jul. 2, 2008.
(60) Provisional application No. 61/151,630, filed on Feb. 11, 2009.

(51) Int. Cl. G06Q 30/00; G06Q 50/00; G06Q 99/00

(52) U.S. Cl. 705/14.55; 705/1

(57) ABSTRACT

Methods for facilitating effective and efficient communication between businesses and customers. A business purchases a “widget package” from a widget service provider that includes a business widget for installation on the business's computer network and a customer widget for installation on a customer's electronic communication device. Once installed, the business widget and the customer widget communicate with one another directly over a network, such as the Internet, in real time and allow the business to compose and send targeted communications to the customer in accordance with a set of preferences specified by the customer in the customer widget. The customer thereby receives only those types of communications which he or she desires.

### CROSS-REFERENCES TO RELATED APPLICATIONS

This application claims the benefit of U.S. Provisional Application No. 61/077,545 filed Jul. 2, 2008 and U.S. Provisional Application No. 61/151,630 filed Feb. 11, 2009 which are incorporated herein by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to business-to-consumer (B2C) and business-to-business (B2B) communications, and relates more particularly to methods for facilitating effective and efficient non-email communication between businesses and their existing and potential customers.

2. Description of the Related Art

Currently, the vast majority of information sent from a business to existing or potential customers is delivered via electronic mail, or “e-mail”. E-mails are generated by a “host” and are then sent thru the host's e-mail server to a “user” e-mail server across un-secured Internet channels. The “user” e-mail server, which also houses perhaps millions of other un-secured e-mails, then parses the mail out to an end recipient. Then, according to settings and filters on the “user” e-mail server and the individual settings on the personal computer of the recipient, the mail is either sent to a “spam mail” folder or to the regular mail folder, or “inbox,” of the recipient's e-mail application. These e-mails are typically read or discarded by the recipient based on the title of the message. For example, if a message has a title that sounds like a generic mass-communication, the message will often be discarded. In fact, studies show that less than 1% of e-mails sent from online retailers are ever opened by consumers. It is therefore difficult for businesses to communicate effectively and efficiently with customers, and it is difficult and time consuming for customers to decipher which messages they are interested in reading among an unsolicited multitude of messages that they do not wish to view.

Additional problems commonly associated with e-mail correspondence between businesses and existing or potential customers include the following:
E-mails are sent through unsecured channels and can therefore be intercepted;
E-mail filters and spam settings are designed to filter out exactly these types of e-mail;
If the e-mail title is not recognized as needed by the consumer, it will often never be opened;
Since many e-mail addresses can be “stolen,” a spammer or hacker can buy a similar name to that of a business and use it to send viruses to recipients. For example, bestbuy.com could be “stolen” by using best-buy.com—a slight variation of the real name, and an interested recipient could inadvertently open a message containing a virus from the imposter;
Since most people now receive hundreds of e-mails per month, or even per day, most e-mails are deleted by a recipient without ever being opened; and
E-mail accounts have to be accessed by a recipient to retrieve messages. This entails “dropping” a current computer related activity to actively open and “get” the mail. Loss of workday production from checking e-mails is shown to be at an all time high.

It would therefore be advantageous to have a method for facilitating effective and efficient non-email communication between businesses and existing or potential customers.

### BRIEF SUMMARY OF THE INVENTION

In accordance with the present invention, there are provided several methods that reduce the proliferation of “spam” e-mails by transferring the control of certain communications from businesses to consumers. Consumers decide how, when and by whom they are contacted by installing specialized software “widgets” on their computer, smart phone, cell phone or other electronic communication device. The consumer then instructs the software regarding the types of communications he or she wishes to receive. For example, the consumer can decide to receive notices about auto dealer specials on service, but to avoid notices on new car sales.

The methods of the present invention are enabled by “widget” technology that has been developed over the past decade. “Widgets” are currently being used by most internet users, but are not known to typical consumers by what they are called, only by what they do. The most common of these is the “weather” widget on most web browsers. In this widget, the current weather and temperature conditions are displayed discreetly on a user's computer desktop at all times. Through Internet communication with a widget service provider, the weather widget updates automatically without any input by the user, when weather conditions change. Widget technology thus allows all data from the widget service provider to be sent directly to the user in real time without any effort from the user, aside from initially installing the widget application on his or her electronic communication device.

In the context of the present invention, widget technology enables a business to eliminate inefficiencies associated with conventional communication channels by offering a direct, solicited link to its customer base. This is preferably accomplished by the business purchasing a “widget package” from a widget service provider for a monthly subscription fee. The business identifies to the provider numerous functional and/or design features that it would like to have incorporated into its customized “widget package”. A widget package includes one or more customized widgets for use by the business (“business widget”), as well as a customized widget for use by the business's customers (“customer widget”). The provider then installs the business widget(s) on the business's computer network and makes the customer widget available for download on a central website maintained by the provider. By utilizing the business widget, the business can send direct, real-time communications to the customer's widget. Additionally, the customer can specify to the customer widget that he or she only desires to receive particular types of communications from the business (e.g., promotional offers, but not new product notices). The methods of the present invention thereby permit information desired by a customer to be shared in real time in a passive, uninterruptible manner based on the customer's preferences.

One exemplary embodiment of the present invention allows automotive service centers to share real-time information about vehicle service status with customers, thereby reducing call volumes. By lessening the communication load required to deliver routine notices to customers (such as by telephone call), service representatives can focus more time on managing the overall customer service process. The service center can additionally track customer intervention times, service delivery response rates and score customer satisfaction through interactive customer surveys delivered in real time. The methods of the present invention thus allow businesses to reduce the amount of time, money and effort expended in communicating with customers.

The communication methods of the present invention can be incorporated into virtually any service or sales application for improving the efficiency and effectiveness of communications between businesses and customers.

It is therefore an objective of the present invention to enhance the customer experience by providing real-time communication capabilities between a business and its customers. It is a further objective of the present invention to reduce the volume of unwanted e-mail communications from businesses to consumers and to replace them with communications consumers want to receive. It is a further objective of the present invention to provide a robust, reliable link between consumers and businesses that helps businesses manage communication in an efficient manner. It is a further objective of the present invention to provide a software communication platform of choice for both businesses and consumers and to provide businesses with a repeatable monthly subscription business model.

### BRIEF DESCRIPTION OF THE SEVERAL VIEWS OF THE DRAWINGS

FIG. 1 is a flowchart illustrating a broad embodiment of the methods enabled by the present invention.

FIG. 2 is a flowchart illustrating a first exemplary embodiment of the methods enabled by the present invention.

FIG. 3 is a flowchart illustrating a second exemplary embodiment of the methods enabled by the present invention.

FIG. 4 is a flowchart illustrating a third exemplary embodiment of the methods enabled by the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

The present invention includes methods for providing improved business-to-business (B2B), business-to-consumer (B2C), and consumer-to-business (C2B) communication for facilitating greater efficiency and convenience in the sales and service sectors. The methods of the invention are preferably implemented by software “widget” applications, hereafter referred to as “widgets”, that will be familiar to those skilled in the art. Such applications can be incorporated into the architecture of conventional e-commerce websites or can be stored and executed on a user's electronic communication device, such as a personal computer or a cell phone.

Various electronic communications and interactions between businesses and consumers will be described herein. Such communications and interactions are facilitated by conventional network access means that may include wired and wireless Internet connections, voice and data telecommunications connections, local area networks (LAN), wide area networks (WAN) and virtual private networks (VPN). Although one form of communication or interaction is specified, a person of ordinary skill will understand how to use other forms as a substitute. Thus, when one form is described, the reader should note that others are contemplated.

It will be understood by persons having ordinary skill in the art that the methods enabled by the widgets of the present invention can be used in other non-software applications, and that the widgets can be modified and enhanced in such ways as to change their functionality while retaining the essential elements of the invention. The particular software language and software code used to implement the methods embodied by the widgets described herein are not critical to the invention and will therefore not be described in detail.

A first aspect of the methods enabled by the present invention involves communication between a service-oriented business and a customer. A “service-oriented business” is defined herein as any business that provides one or more services to customers, including, but not limited to, automotive service, educational and child care services, medical service and financial service. A customer can be an individual or another business.

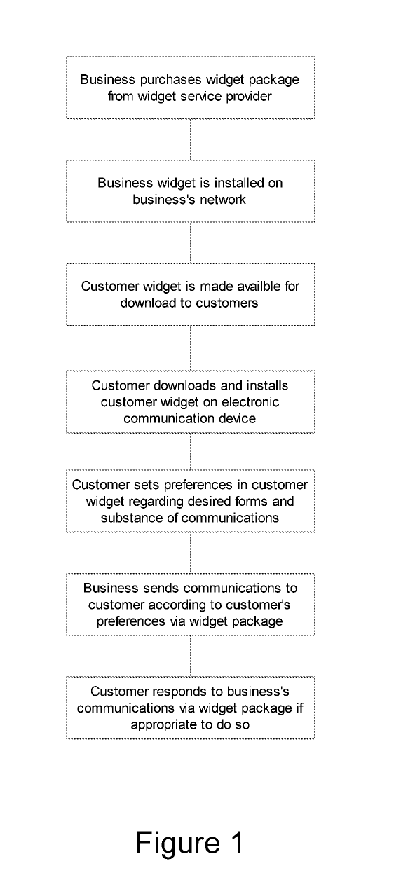

Referring to FIG. 1, a service-oriented business generally first approaches, or is approached by, a “widget service provider”. A “widget service provider” is an entity that develops widget applications, such as those described herein, and provides such widget applications to interested businesses for a fee, such as a monthly subscription fee. A widget service provider also provides an online hub for relaying communications between businesses and consumers in a manner similar to an e-mail server, as will be described in greater detail below.

Upon entering into a service agreement with a widget service provider, a service-oriented business identifies to the provider numerous functional and/or design features that it would like to have incorporated into a customized “widget package” that includes one or more customized widgets for use by the business (“business widget”), as well as a customized widget for use by the business's customers (“customer widget”). Features that may be incorporated into such a package include messaging options, audio and video communication capabilities and aesthetic elements such as the business's logo or color scheme.

After the widget package is completed and is approved by the business, the provider then installs the business widget(s) on specified computers on the business's computer network and makes the customer widget available for download on a central website maintained by the provider. The customer widget can additionally or alternatively be made available for download on the business's website.

Next, when a customer enlists the service of the service-oriented business, such as by making conventional arrangements to have the service performed (e.g., by providing contact information, scheduling a time for service, dropping off an item to be serviced, setting up an account with the business, etc.), the business preferably asks the customer to provide an e-mail address at which the customer can be contacted. The business then establishes an electronic customer profile that is preferably stored in a customer database on a server maintained by the widget service provider. The business also provides the customer with log-in information, such as a unique username and/or password that are associated with the customer's profile. Alternatively, such log-in formation can be sent to the customer via the provided e-mail address.

Next, the business e-mails a hyperlink to the customer that will direct the customer to the website where the customer can download the customer widget (described above). The customer then downloads the customer widget onto his or her electronic communication device and installs the widget thereon in a conventional manner. Once the widget is installed and executed, the widget initiates network communication between the customer's electronic communication device and the widget service provider's server, such as via the Internet. The customer is simultaneously presented with a dashboard-type graphical user interface (GUI) that is similar to those used in many widget applications and that displays the various features of the widget. Additionally, a widget icon associated with the customer widget is installed on the device's desktop, such as on a conventional task bar. The customer widget will subsequently be continuously active and in communication with the widget service provider's server without requiring the user to take any further action, assuming the electronic communication device is powered on and is able to connect to an appropriate network.

Initially, the customer widget preferably asks the customer to enter the previously provided log-in information (described above). The log-in information is then transmitted to the widget service provider's server and is matched with the customer's established profile, thereby positively identifying the customer and instructing the server to open a line of communication between the customer widget and the business widget of the relevant service-oriented business. The customer is then asked to specify a number of personal preferences, such as the type of information he or she would like to receive from the service-oriented business via the widget (e.g., service updates and reminders), as well as additional channels of communication (e.g., SMS message or e-mail) through which the customer would like to receive such information.

Once the customer widget has been installed and configured, the customer's name will thereafter appear in a “customer list” that is displayed to users of the business widget. A “customer list” is a list of all of the business's customers that have installed and configured a corresponding customer widget and can therefore be communicated with via the widget package. The service-oriented business can then use the messaging capabilities of the business widget to communicate approved types of information, i.e., those explicitly approved by a customer, directly to the customer's electronic communication device in real time. For example, the business can create and send text and/or audio and video messages regarding service updates, reminders, incentives and optional additional services. When such communications are received by the customer's electronic communication device, the unobtrusive widget icon on the device's desktop will discretely indicate that a communication has been received, such as by changing to a different icon that is representative of the specific type of communication received. The business can thereby send a communication to the customer and make the customer aware of the communication without requiring the customer to perform any active steps, such as he or she would typically be required to do in the case of e-mail communications, for example.

By clicking on the widget icon, the customer can open the “dashboard” of the customer widget where the communication from the business will appear for review. If it is appropriate to do so, the customer can then use the messaging capabilities of the customer widget to send a responsive communication to the business in real time. The customer can also use the customer widget to initiate communication with the business without first being contacted by the business, such as to schedule a future service or make a specific inquiry about a service that is in progress. Additionally, the widget package informs the sender of a communication when the recipient has reviewed the communication. The sender, whether it be the business or the customer, can thereby be assured that its communication has been received and reviewed. Furthermore, the widget application allows the sender of a communication to retract the communication at any time before it has been reviewed.

The service communication methods discussed above will now be described in greater detail by way of two specific, exemplary applications.

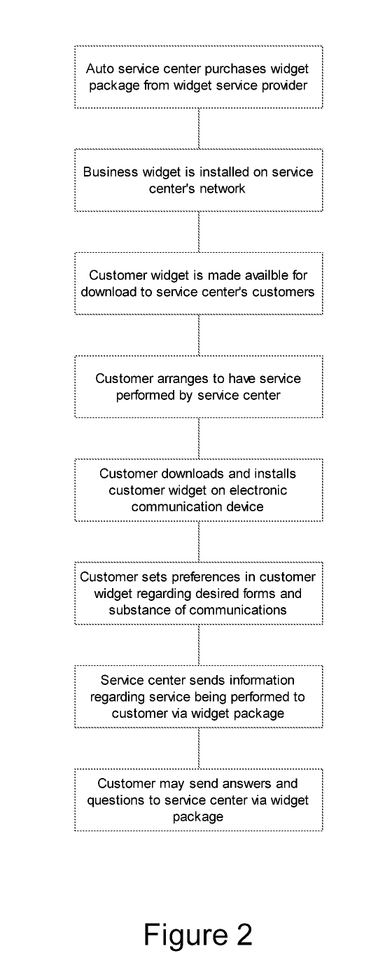

Referring to FIG. 2, a first exemplary embodiment of the service communication methods discussed above is depicted wherein the service-oriented business is an automotive service department (hereafter referred to as “Auto”) and the customer is an individual (hereafter referred to as “Bob”) in need of automotive service. If Bob has previously installed and configured Auto's customer service widget on his electronic communication device, Auto can send approved types of communications to Bob in real time. For example, if Bob specified to the customer widget that he would like to receive communications regarding only service updates and service reminders (but not communications regarding specials on discounted services, for example), then Auto can automatically or manually send Bob a reminder that his car is due for a routine service. If Bob previously specified that he would also like to receive communications from Auto via text message, Auto will also send a text message to Bob's cell phone or smart phone reminding him of the service. The widget icon on Bob's desktop that corresponds to Auto's customer widget, which normally appears as an icon of Auto's business logo, would then immediately indicate that a communication regarding a service reminder has been received, such as by changing to an icon of a hammer and a wrench. Upon Bob clicking on the icon, the customer widget would open and present Bob with the service reminder, at which point Bob can ask for a service appointment, ask a question regarding the service or dismiss the reminder.

If Bob responds to the service reminder by asking for a service appointment, an advisor at Auto will then respond with one or more available appointment slots and will ask Bob to confirm, decline or suggest a new appointment. After an appointment slot has finally been confirmed, Bob will drop his car off at Auto at the agreed upon time. Thereafter, a service technician working on Bob's car uses the business widget to send service updates to Bob's electronic communication device regarding the progression of the service in real time. For example, the technician can notify Bob when his car has initially been brought into the service bay, when his car is on the lift being serviced and when his car is being washed after the service is complete. This eliminates the need for Bob to call Auto numerous times throughout the day to check on the status of the service, which is time consuming and inefficient for both Bob and Auto.

The business widget also allows the technician to conveniently alert Bob regarding any unforeseen problems and/or to ask Bob whether or not he would be interested in having additional services performed. For example, if the technician finds that Bob's car is in need of new brake rotors, the technician can quickly and easily create and send a video message to Bob using a conventional webcam wherein the technician explains the rotor problem, shows Bob the existing worn rotors, as well as a set of potential replacement rotors, and asks Bob whether he would like the technician to install the new rotors. Bob is then presented with the option of accepting or declining the additional service, such as by clicking a button in the customer widget labeled “accept” or “decline”, at which time the technician will immediately be informed of Bob's answer. Such communications between Bob and Auto are preferably stored electronically in association with Bob's customer profile (described above) so that potential future disputes regarding Bob's acceptance or refusal of services can be easily resolved.

Upon completion of the requested services, Auto will communicate to Bob that his car is ready to be picked up, such as by causing the widget icon on Bob's desktop to change into an icon of a car over a green background. Bob can then open the customer widget and notify Auto that he will be in shortly to pick up his car, or notify Auto that he will need a shuttle to pick him up (if such a service is offered). After Bob picks up his car, Auto can use the business widget to send Bob a customer survey for evaluating his service experience if Bob has previously specified that he would like to receive such communications. Additionally, an employee of Auto, such as the service technician or a customer service representative, can send Bob a video message wherein the employee thanks Bob for his patronage.

An additional feature that is preferably incorporated into the business widget is a “customer filter” for allowing a business to send a message to a plurality of customers based on a set of specified customer criteria. For instance, using the example above, Auto may receive a recall notice from Ford stating that all 2007-2008 Mustang GTs should be serviced to resolve a brake problem. Auto can then use the business widget to compose a recall communication and can specify to the business widget that the communication should be sent to all of Auto's customers who own a 2007-2008 Ford Mustang GT, such as by selecting automobile criteria from drop down menus in a “customer filter” screen of the business widget. Upon being instructed to send the communication, the business widget will match the specified criteria against the customer profiles stored in the customer database (described above) and the recall communication will be sent only to those customers whose profiles indicate that they own a 2007-2008 Ford Mustang GT and who have indicated that they would like to receive communications from Auto regarding recalls. The widget icon on the customers' desktops may then be caused to change to an icon representing a recall notice, such as an icon of a hazard sign over a red or yellow background. The customers can then open their customer widgets and arrange for an appropriate service in the manner described above.

The above-described process eliminates the need for customers to call the service center to check on the progress of their vehicles. Further, it eliminates the need for the service center to wait on hold or track down customers to let them know their car is ready for pickup. Customers can also pay for their repairs and service online upon notification of completion, such as by being directed to a payment processing portion of the service center's website by the customer widget. Upon notice of payment, the service center can have the car waiting for the customer, rather than the customer waiting for the car. Improved customer service translates into repeat, loyal clients.

Internally, within Auto's business, the business widget allows each employee to communicate with and monitor the status of other employees. For example, each employee of Auto can be represented in the business widget by a unique icon and an accompanying status indictor in a manner similar to conventional instant messaging applications. By simply reviewing the business widget, a customer service representative within Auto can conveniently see which technicians are working on which service assignments, as well as the status of each service assignment. Auto can thereby maintain a complete listing of all service issues for all vehicles under management, and there is no need to check with service technicians about a vehicle's status. Auto can also use the business widget to track and report the efficiency of its operations and can thereby set and maintain accurate operational benchmarks. Operational “bottlenecks” can therefore be identified and remedied to improve timeliness, efficiency, and overall customer satisfaction.

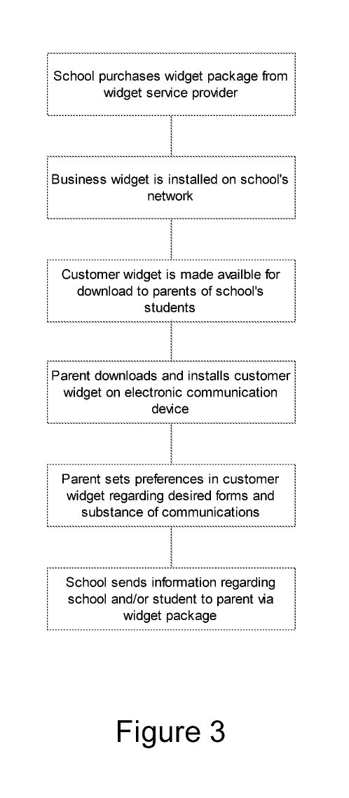

Referring to FIG. 3, a second exemplary embodiment of the service communication methods discussed above is depicted wherein the service-oriented business is an educational institution, such as a middle school or a high school (hereafter referred to as “School”), and the customer is a parent (hereafter referred to as “Parent”) of one of School's students (hereafter referred to as “Student”). Upon Student's enrollment into School, or at the beginning of each school year, Parent is required to download and install School's customer widget on his or her electronic communication device, and School creates a unique profile for Student that includes information such as Student's grade level, Student's teachers, extracurricular activities that Student will be involved in and Parent's contact information. School can thereafter use its business widget to send approved communications to Parent, such as notifications regarding school closures, extracurricular activities, emergencies and problematic incidents involving Student.

For example, it is currently typical for parents of students to have to constantly monitor nightly news reports to learn of next-day school closures during snow storms or other inclement weather. By using the business widget, however, School can instantly notify the parents of all of its students regarding the announcement of a closure by issuing a single mass communication, thereby removing the burden from the parents.

In another example, if Student were to become ill in the middle of a school day and needed to be picked up by Parent, a school nurse or administrator would typically be tasked with tracking down Parent through repeated phone calls to one or more contact phone numbers previously provided by Parent. By using the business widget, however, the nurse can issue a single communication that would be sent to Parent via all previously specified channels of communication. Upon receipt and review of the communication, Parent can then quickly respond to the nurse using the customer widget and inform the nurse of a time at which Parent can pick up Student. Parent then picks student up at or around the stated time. Additionally, if the nurse's original communication is sent to both of Student's parents and the nurse is subsequently notified by the business widget that the communication has been received and reviewed by one of the parents, the nurse can instruct the business widget to retract the communication from the customer widget of the other parent to avoid confusion amongst the parents regarding who has and who has not received the communication.

Additionally, School can use the “customer filter” feature of the business widget described above to quickly and easily send a targeted communication to the parents of a particular segment of students. For example, if a planned field trip for Mr. Smith's 6^{th} grade biology class were cancelled on short notice, Mr. Smith or a school administrator could use the business widget to compose a cancellation notice, and can specify to the business widget that the communication should be sent to all of Mr. Smith's 6^{th} grade biology students, such as by selecting student criteria from drop down menus in a “customer filter” screen of the business widget. Upon being instructed to send the communication, the business widget will match the specified criteria against the profiles of the students stored in the customer database (described above) and the cancellation notice will be sent only to the parents of the students of Mr. Smith's 6^{th} grade biology class who have indicated that they would like to receive communications from School regarding such cancellations. The widget icon on the parents' desktops may then be caused to change to an icon representing a cancellation notice, such as an icon of an “X” over a red background. The parents can then open their customer widgets to read the notice, thereby automatically communicating to the business widget that they have in fact received and reviewed the notice. School will then know if any parents have not received and/or reviewed the notice, and can subsequently take special measures to contact only those parents through alternative channels.

A second aspect of the methods enabled by the present invention involves communication between a sales-oriented business and a consumer. A “sales-oriented business” is defined herein as any business that sells one or more products to customers and that manages parts and inventory. A customer can be an individual or another business (i.e., B2B or B2C).

Within the context of a sales-oriented business the development, acquisition and initial implementation of a widget package are performed in a substantially identical manner to the development, acquisition, and initial implementation of the widget package in the above-described service context. That is, a sales-oriented business will generally acquire a customized widget package from a widget service provider, and customers of the sales-oriented business will install the business's customer widget on their electronic communication devices to facilitate improved communication with the business. Additionally, customers can similarly specify the types of communication they would like to receive from the sales-oriented business, as well as additional channels of communication they would like to receive such communications through. For example, a customer can choose to receive, or opt out of receiving, particular communications from the sales-oriented business such as special offers, new product notices, promotional offers, coupons, rebates, payment reminders, etc.

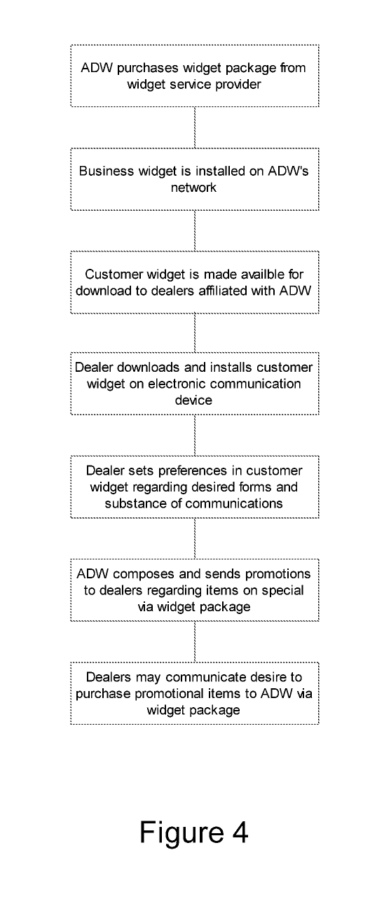

It should be noted that the widget package of the sales context differs slightly from the widget package of the service context in that the former provides features that allow a sales-oriented business to easily compose and distribute sales offers and promotions in B2B and B2C contexts for items sold by the business. These features will now be described in greater detail by way of a specific, exemplary application depicted in FIG. 4 wherein the sales-oriented business is a wholesale auto parts distributor, also known as an automotive distributors warehouse (ADW), and the customers are automobile dealers (hereafter referred to as “the Dealers”) in the ADW's regional network of dealers (i.e., dealers that buy wholesale automotive parts exclusively from the ADW for resale to end consumers). It should be understood, however, that methods similar to those enabled by the exemplary widget package described below can be implemented in virtually any type of sales application or parts and inventory management application, such as retail sales, real estate sales, insurance sales, other wholesale settings, and conventional parts and inventory management settings.

During the normal course of business between the ADW and the Dealers, the ADW will occasionally offer the Dealers promotions or daily specials on particular items, such as when the ADW has a surplus of an item that the ADW wishes to rid from its inventory. By implementing a promotion creation feature of the business widget, the ADW can compose a customized promotional offer for distribution to the Dealers. For example, when the ADW instructs the business widget to create a new promotion for an item, such as by clicking a button in the widget labeled “new promotion”, the business widget will instruct the ADW to input certain information about the promotion, such as the name of the item to be promoted, the quantity of the item available, the promotional price of the item and the amount of time the promotion will run before it expires. The ADW can also append a picture of the item, a textual message or a promotional video of the promotion if desired. Once the ADW has finished composing the promotion, it sends the promotion to the Dealers for review, such as by clicking a button in the business widget labeled “Send”. The promotion will then be added to a promotion list in the business widget that contains a listing of all of the ADW's current and expired promotions (the ADW can have multiple promotions running simultaneously).

Once a promotion has been sent by the ADW, the promotion will immediately appear in the customer widgets of the Dealers, such as by changing the widget icon on the Dealers' desktop, which is normally an icon of the ADW's logo, to an icon of a dollar sign or some similar indicium of a promotional sale. By clicking on the icon, the Dealer can open the customer widget and view the promotion, including any pictures, textual message or promotional video that may have been appended by the ADW. The promotion appears to the Dealers in a Home Shopping Network style, wherein the customer widget presents a window containing a picture and a description of the promotional item, a price of the item, a counter displaying the available quantity of the item and a timer counting down to the expiration of the promotion if an expiration time has been set by the ADW. The customer widget also presents a field into which a dealer can enter a quantity desired, as well as fields into which purchase information, such as a purchase order number, can be entered.

When the Dealer instructs the customer widget to purchase a particular quantity of the promotional item, such as by filling in any necessary fields and clicking a button in the widget labeled “Purchase” or some variation thereof, a notification of the purchase is immediately transmitted to the business widget of the ADW and the purchasing dealer's name and purchase information will be added to a transaction list in the business widget. The ADW can then fill the order and ship the purchased items to the dealer at a later time. The ADW can also print and archive the order if it so desires. Additionally, the quantity of the promotional item purchased by the Dealer will be automatically and immediately subtracted from the quantity counter displayed in the promotion window of each dealer's customer widget. Once the quantity counter reaches zero, the promotion will be retracted and will no longer appear in the Dealer's customer widgets, thereby preventing any orders that cannot be fulfilled. The promotion will similarly be retracted when the expiration timer reaches zero.

Another advantageous feature of the promotion creation function of the business widget is that the ADW can end or edit any of its current promotions at any time, such as by selecting a promotion in the promotion list of the business widget and clicking a button labeled “End” or “Edit.” This is particularly beneficial in a situation where the ADW, soon after starting a new promotion, receives a purchase offer from a prospective buyer that is unaware of the promotion at a price that is higher than the promotional price. In such a case, the ADW can immediately retract the issued promotion and instead sell the promotional item at the higher price.

Furthermore, the ADW can use a filter function of the business widget, similar to the filter function described above in the service-oriented business context, to send targeted promotions to specific dealers or subgroups of dealers. For example, if the ADW has a surplus of brake pads for a particular Chevrolet model, it may wish to compose a promotion for that item. By using the filter function of the business widget, the ADW can specify that the promotion should be sent only to Chevrolet dealers within its network.

In addition to facilitating communications that are generally more efficient and more convenient than traditional channels of B2B and B2C communication, the methods enabled by the widget technology described above avoid problems associated with traditional communication channels, such as e-mail, by offering the following advantages:
Since widget communication is direct, no filters or settings will interrupt the flow of information, so the customer receives everything he or she chooses to receive.
Spam or viruses cannot be attached to widget communications since they are sent directly from a widget service provider to the user—so they are “hacker safe”.
All information sent to the customer widget is “subscribed to” by the customer, so he or she can option into or out of many updates and reminders (as described above).
A widget is a “live” interface between a business and a customer, so the customer never needs to stop the current activity on his or her electronic communication device to review the status of the widget.

This detailed description in connection with the drawings is intended principally as a description of the presently preferred embodiments of the invention, and is not intended to represent the only form in which the present invention may be constructed or utilized. The description sets forth the designs, functions, means and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for facilitating communication between a business and customers through the use of widget software applications, the method comprising:
(a) installing a business widget on at least one electronic communication device of the business;
(b) installing a customer widget on an electronic communication device of at least one customer, the customer widget being in communication with the business widget over a network connection;
(c) the customer specifying to the customer widget particular types of information that the customer would like to receive from the business; and
(d) the business using the business widget to send the specified types of information to the customer widget for review by said at least one customer.

2. A method for facilitating communication between a business and customers through the use of widget software applications, the method comprising:
(a) the business purchasing a widget package from a widget service provider, the widget package including a business widget and a separate customer widget;
installing the business widget on at least one electronic communication device of the business;
(b) making the customer widget available for download to at least one customer;
(c) installing the customer widget on an electronic communication device of said at least one customer, the customer widget being capable of communicating with the business widget over a network connection;
(d) the customer specifying to the customer widget particular types of information that the customer would like to receive from the business; and
(e) the business using the business widget to send the specified types of information to the customer widget for review by said at least one customer.

3. The method in accordance with claim 2, wherein the business is an automobile service center and said at least one customer is an owner of an automobile being serviced by the service center, the method further comprising the service center using the business widget to send updates to the customer widget regarding the status of any service being performed on the automobile.

4. The method in accordance with claim 2, wherein the business is a school and said at least one customer is a parent of a student at the school, the method further comprising the school using the business widget to send information to the customer widget regarding the school.

5. The method in accordance with claim 2, wherein the business is a school and said at least one customer is a parent of a student at the school, the method further comprising the school using the business widget to send information to the customer widget regarding the student.

6. The method in accordance with claim 2, wherein the business is an auto parts supplier and said at least one customer is an automobile dealership on the supplier's dealer network, the method further comprising the supplier using the business widget to compose and send interactive promotions to the customer widget regarding items sold by the supplier.

7. The method in accordance with claim 6, further comprising the dealership using the customer widget to communicate to the business widget that the dealer would like to purchase a quantity of the promotional item from the supplier.
